(19) United States
(12) Patent Application Publication
(10) Pub. No.: US 2003/0221513 A1
(43) Pub. Date: Dec. 4, 2003

(54) Assembly, in particular a vehicle steering wheel covering assembly

(75) Inventor: Ralf Heindl, Aschaffenburg (DE)

Correspondence Address: TAROLLI,SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/447,088

(22) Filed: May 28, 2003

(30) Foreign Application Priority Data
May 31, 2002 (DE) 202 08 461.2

(51) Int. Cl. G05G 1/00

(52) U.S. Cl. 74/566

(57) ABSTRACT

An assembly comprising a component with a through bore for a tool and a shield to cover the through bore is provided. The shield has a fastening section and an at least partially elastic cover section, which is movable with respect to the fastening section so that it covers the through bore in a first position and exposes the through bore in a second position. The fastening section is fastened to the component a distance away from the through bore and the shield is endeavouring to move automatically into the first position in which the through bore is covered.

### FIELD OF THE INVENTION

The invention relates to an assembly, in particular a vehicle steering wheel covering assembly, comprising a component with a through bore for a tool and a shield to cover the through bore.

### BACKGROUND OF THE INVENTION

With the installation of a steering wheel, it is desirable that a gas bag module is inserted at as late a stage in manufacturing as possible. This leads to through bores having to be provided in the outer covering of the steering wheel, through which the screws, for example for fastening the gas bag module inside the steering wheel, are accessible to a tool. Such through bores, however, interrupt the uniform appearance of the covering and therefore represent a visual intrusion. It is known to cover larger access openings with camouflage caps, which in turn, however, again have through bores, through which the screws of the gas bag module are accessible at the customer's. The through bores either remain open and disturb the appearance, or they have to be covered individually with caps at the customer's side, the additional installation expenditure being a disadvantage.

### BRIEF SUMMARY OF THE INVENTION

The present invention provides a possibility for providing a component with a shield, with which no additional installation work is required for the customer.

This is achieved in an assembly comprising a component with a through bore for a tool and a shield to cover the through bore. The shield has a fastening section and an at least partially elastic cover section, which is movable with respect to the fastening section so that it covers the through bore in a first position and exposes the through bore in a second position. The fastening section is fastened to the component a distance away from the through bore, and the shield is endeavouring to move automatically into the first position in which the through bore is covered. The cover section is movable with respect to the fastening section, in particular is elastically flexible, so that it covers the through bore in one position and exposes the through bore in another position. The shield is constructed so that it endeavours to move automatically into the first position in which the through bore is covered, the movement being induced by the elasticity of the shield. The invention allows the shield to be delivered to the customer already installed on the covering of the steering wheel or on the camouflage cap over an access opening. For the installation of the gas bag module, the cover section of the shield can then be moved aside by a suitable tool, e.g. a screwdriver, and the screws of the gas bag module can be tightened. As soon as the tool is withdrawn from the through bore again, the elastic section makes provision that the cover section places itself over the through bore again and covers the latter completely.

Preferably, the shield is a separate component with respect to the component having the through bore. Usually, the shield and the component with the through bore are made from different materials.

Of course, the use of the invention is not restricted to steering wheels, but rather it can be used for any object in which a component lying therebeneath is to be accessible through an opening in a covering.

The shield preferably has an elongated shape, the fastening section being arranged in the extension of the cover section. Either only a portion of the cover section adjoining the fastening section is constructed so as to be elastic, or the shield consists entirely of an elastic material, e.g. rubber or elastomer. In both cases, the shape of the shield makes provision in a simple manner that the cover section flaps back into its initial position after a movement, in which initial position it covers the through bore.

The shield is arranged most favourably on the inner face of the component.

Preferably, the cover section of the shield has a projection, which can engage into the through bore in a form-fitting manner. In this way, a continuous surface is produced on the outer face of the covering in the region of the through bore.

When the edges of the projection and of the through bore have a conical shape, this facilitates the guiding of the projection into the through bore when the cover section flaps back.

It is possible to connect the fastening section with the component by means of a detent connection, e.g. openings can be provided in the fastening section, whilst one or more detent protuberances are constructed on the component, over which the fastening section is drawn. However, the fastening section can also be connected with the component in another suitable manner, e.g. by glueing.

The invention further provides a vehicle steering wheel cover assembly comprising a steering wheel covering for being arranged on a rear side of a steering wheel, the covering having a through bore for a tool, and a shield for covering the through bore. The shield has a fastening section and an at least partially elastic cover section. The cover section is movable with respect to the fastening section so that the cover section covers the through bore in a first position and exposes the through bore in a second position. Further, the fastening section is fastened to the covering a distance away from the through bore and the shield endeavours to move automatically into the first position in which the through bore is covered.

### BRIEF DESCRIPTION OF THE DRAWINGS

FIG. 1 shows a diagrammatic section through an assembly according to the invention, in this case a steering wheel in the region of the rear face;

FIG. 2 shows an enlarged cut-out of FIG. 1 with closed through bore; and

FIG. 3 shows the cut-out of FIG. 2 with a shield opened by a tool.

### DETAILED DESCRIPTION OF THE PREFERRED EMBODIMENT

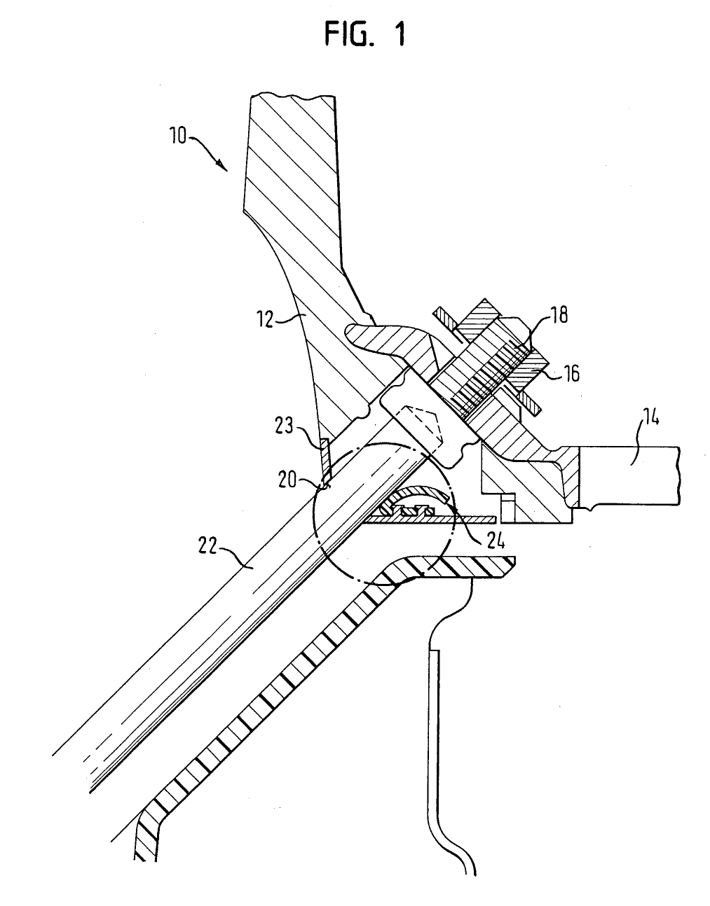

In FIG. 1 a steering wheel 10 is illustrated, with a vehicle steering wheel covering assembly having an outer covering 12 on the rear face, a skeleton 14 and a gas bag module 16, which is only shown in the region of its fastening and which is to be connected to the skeleton 14 by means of a screw 18.

For this purpose, a through bore 20 is provided in the covering 12, through which the screw 18 is accessible by a tool 22. The covering 12 in this example has a larger access opening, which is closed by a camouflage cap 23 belonging to the covering 12, the through bore being arranged in the camouflage cap 23.

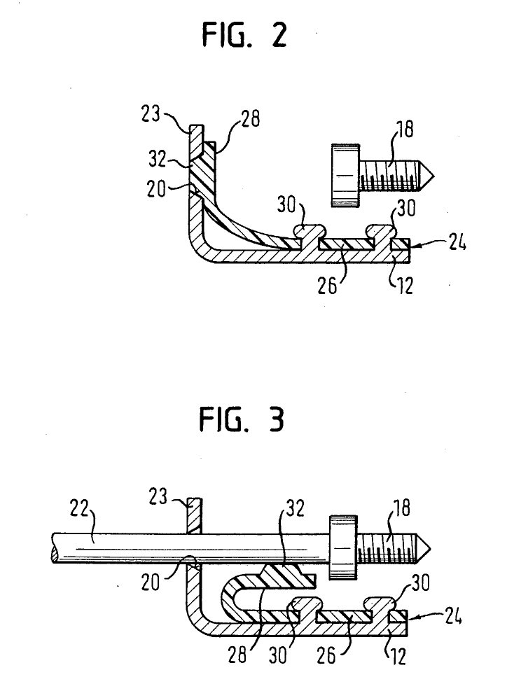

In FIGS. 2 and 3, the region enclosed by a circle in FIG. 1 is illustrated on an enlarged scale.

In order to cover the through bore 20 after the screw 18 has been tightened, a shield 24 is arranged on the inner face of the covering 12 or of the camouflage cap 23.

The shield 24 has a fastening section 26 and a cover section 28. The fastening section 26 and the cover section 28 are arranged in extension of each other, so that the shield 24 as a whole has an elongated shape.

In the present example, detent protuberances 30 or thermally formed rivet-like projections are constructed in the covering 12 or camouflage cap 23, by means of which the shield 24 is fastened to the covering 12 via a snap-in connection.

In an initial or first position, the cover section 28 lies over the through bore 20 and covers the latter (FIGS. 1, 2). On the cover section 28, a projection 32 is provided, which is coordinated with the through bore 20. The edges of the projection 32 and of the through bore 20 are chamfered, as can be seen particularly well in FIG. 3, so that the projection 32 is automatically centred, when it comes into engagement with the through bore 20. When the projection 32 sits in the through bore 20, so that the cover section 28 covers the through bore 20, the outer face of the covering 12 and the projection 32 form a smooth surface.

The shield 24 consists of an elastic material, so that on the one hand the cover section 28 can be moved towards the fastening section 26 and on the other hand, with a movement a restoring force is produced, through which the cover section is moved back into its initial position again. The shield 24 is arranged on the covering 12 so that the cover section 28 is prestressed against the through bore 20. In the example shown, this is favoured in that the through bore 20 is situated in a corner of the covering 12, so that the shield 24 is arranged in bent form in the covering 12.

The shield 24 is a separate component with respect to the covering 12 or to the camouflage cap 23 and is, usually, made from a different material than those parts.

As shown in FIG. 3, the cover section 28 can be pushed aside by the tool 22 into a second position, in which the through bore is exposed, in order to reach the screw 18. When the tool 22 is withdrawn from the through bore 20, the prestressing of the cover section 28 in the direction of the through bore 20 makes provision that the cover section 28 flaps back again into the first position. The conical edges of the projection 32 and the through bore 20 cause the projection 32 to engage securely and completely into the through bore 20 again and to close the latter.

Although the invention has been described here in connection with a steering wheel, the covering 12 can represent any desired component, in particular in the vehicle interior, in which an opening is to be reversibly covered.

1. An assembly comprising:
a component with a through bore for a tool and
a shield for covering said through bore,
said shield having a fastening section and an at least partially elastic cover section,
said cover section being movable with respect to said fastening section so that said cover section covers said through bore in a first position and exposes said through bore in a second position,
said fastening section being fastened to said component a distance away from said through bore and
said shield endeavouring to move automatically into said first position in which said through bore is covered.

2. The assembly according to claim 1, wherein said shield has an elongated shape and said fastening section is arranged in extension of said cover section.

3. The assembly according to claim 1, wherein said cover section is prestressed in a direction toward said first position in which said through bore is covered.

4. The assembly according to claim 1, wherein said shield consists entirely of an elastic material.

5. The assembly according to claim 1, wherein said cover section has a projection which can engage into said through bore in a form-fitting manner.

6. The assembly according to claim 5, wherein the edges of said projection and of said through bore have a conical shape.

7. The assembly according to claim 1, wherein said shield is arranged on an inner face of said component.

8. The assembly according to claim 1, whereint said fastening section is connected with said component by means of a snap-in connection.

9. The assembly according to claim 1, wherein said component is a vehicle steering wheel covering on the rear face.

10. The assembly according to claim 1, wherein said shield is a component separate from said component having said through bore.

11. Vehicle steering wheel covering assembly comprising:
a steering wheel covering for being arranged on a rear side of a steering wheel, said covering having a through bore for a tool,
a shield for covering said through bore,
said shield having a fastening section and an at least partially elastic cover section,
said cover section being movable with respect to said fastening section so that said cover section covers said through bore in a first position and exposes said through bore in a second position,
said fastening section being fastened to said covering a distance away from said through bore and
said shield endeavouring to move automatically into said first position in which said through bore is covered.
